(19) United States
(12) Patent Application Publication
(10) Pub. No.: US 2023/0101535 A1
(43) Pub. Date: Mar. 30, 2023

(54) Retractable and Washable Marker Device

(71) Applicant: Ashley Perez, Horsham, PA (US)

(72) Inventor: Ashley Perez, Horsham, PA (US)

(21) Appl. No.: 17/933,690

(22) Filed: Sep. 20, 2022

Related U.S. Application Data
(60) Provisional application No. 63/247,395, filed on Sep. 23, 2021.

(51) Int. Cl. B43K 24/08; C09D 11/16

(52) U.S. Cl. CPC B43K 24/088; C09D 11/16

(57) ABSTRACT

The present invention relates to a retractable washable marker device. The device is primarily comprised of a barrel, a thrust device, and a marker member saturated with an ink having a tip. The tip can be extended/retracted into the barrel. When not in use, the tip is retracted within the barrel and enclosed in the barrel by at least one flap that covers a first opening of the barrel. In this manner, air is prevented from entering the barrel and drying out the tip and marker member.

### CROSS-REFERENCE TO RELATED APPLICATION

The present application claims priority to, and the benefit of, U.S. Provisional Application No. 63/247,395, which was filed on Sep. 23, 2021, and is incorporated herein by reference in its entirety.

### FIELD OF THE INVENTION

The present invention relates generally to the field of markers. More specifically, the present invention relates to a retractable washable marker device. The device is primarily comprised of a barrel, a thrust device, and a marker member saturated with an ink having a tip. The tip can be extended/retracted into the barrel. When not in use, the tip is retracted within the barrel and enclosed in the barrel by at least one flap that covers a first opening of the barrel. In this manner, air is prevented from entering the barrel and drying out the tip and marker member. Accordingly, the present disclosure makes specific reference thereto. Nonetheless, it is to be appreciated that aspects of the present invention are also equally applicable to other like applications, devices, and methods of manufacture.

### BACKGROUND

Existing markers known in the art feature a removable cap to protect the marker tip from becoming damaged. The cap also prevents the tip from drying out and prevents the tip from inadvertently marking surfaces the marker comes in contact with. However, marker caps create a choking hazard for young children when the cap is not secured on the marker. In addition, markers that dry out due to the cap not being replaced must be thrown away. Further, many individuals with limited physical dexterity may enjoy using markers, but struggle to remove a marker cap.

Therefore, there exists a long-felt need in the art for an improved marker. There also exists a long-felt need in the art for a retractable washable marker device that does not present a choking hazard. In addition, there exists a long-felt need in the art for a retractable washable marker device that does not inadvertently dry out. Further, there exists a long-felt need in the art for a retractable washable marker device that can be easily used by users of limited physical dexterity.

The subject matter disclosed and claimed herein, in one embodiment thereof, comprises a retractable washable marker device. The device is primarily comprised of a barrel, a thrust device, and a marker member saturated with an ink. When in use, the thrust device can be depressed to extend a tip of the marker member from the barrel. When not in use, the tip is retracted within the barrel and is enclosed in the barrel by at least one flap. The flap covers a first opening of the barrel to prevent air from entering the barrel and drying out the tip and marker member.

In this manner, the retractable washable marker device of the present invention accomplishes all of the foregoing objectives and provides an improved marker that does not present a choking hazard. In addition, the device does not inadvertently dry out. Further, the lack of a cap allows the device to be easily used by users with limited physical dexterity.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a retractable washable marker device. The device is primarily comprised of a barrel, a thrust device, and a marker member saturated with an ink. In the preferred embodiment, the barrel is cylindrical in shape. The barrel may also be comprised of at least one grip (preferably positioned at the first end of the barrel) that aids a user in gripping the barrel during use.

At least one marker member is positioned within the barrel, wherein the marker member is preferably made from a polyester material that absorbs ink. The tip of the member is preferably made from a felt material, or other marker material known in the art. The ink is preferably any washable, non-toxic ink of any color known in the art.

The tip exits the first end of the barrel through the first opening of the first end when the end of the thrust device is pressed downward into the barrel. This causes at least one spring within the barrel to press against the opening and force the tip out of the opening. The opening is preferably comprised of two (but at least one) silicone flaps that ensure the tip does not dry out when retracted in the barrel (when not in use) by sealing the barrel from the outside air.

The thrust device is located at the second end and can be pushed downward into the barrel through a second opening to cause the tip to protrude from the first opening and remain protruded until the thrust device is pressed again. When the tip is retracted into the barrel while not in use, the end of the thrust device protrudes outward from the second opening.

Accordingly, the retractable washable marker device of the present invention is particularly advantageous as it provides an improved marker. As a result, the device does not present a choking hazard and is not susceptible to inadvertently drying out. Further, the lack of a cap allows the device to be easily used by users with limited physical dexterity. In this manner, the retractable washable marker device overcomes the limitations of existing markers known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a retractable washable marker device of the present invention with a marker member tip extended in accordance with the disclosed architecture; and

FIG. 2 illustrates multiple perspective views of one potential embodiment of a retractable washable marker device of the present invention with a marker member tip extended and retracted in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved marker. There also exists a long-felt need in the art for a retractable washable marker device that does not present a choking hazard. In addition, there exists a long-felt need in the art for a retractable washable marker device that does not inadvertently dry out. Further, there exists a long-felt need in the art for a retractable washable marker device that can be easily used by users of limited physical dexterity.

The present invention, in one exemplary embodiment, is comprised of a retractable washable marker device primarily comprised of a barrel, a thrust device, and a marker member saturated with an ink. The barrel is preferably cylindrical and may also be comprised of at least one grip. The grip is preferably positioned at the first end of the barrel and aids a user in gripping the barrel during use.

At least one marker member is positioned within the barrel. The marker member is preferably made from a polyester material that absorbs ink, and wherein a tip of the member is preferably made from a felt material or other marker material known in the art. The ink is preferably any washable, non-toxic ink of any color known in the art.

The tip exits the first end of the barrel through the first opening of the first end when the end of the thrust device is pressed downward into the barrel. This causes at least one spring within the barrel to press against the opening and forces the tip out of the opening. The opening is preferably comprised of two (but at least one) silicone flaps. The flaps ensure the tip does not dry out when retracted in the barrel (when not in use) by sealing the barrel from the outside air.

The thrust device is located at the second end and can be pushed downward into the barrel through a second opening to causes the tip to protrude from the first opening and remain protruded until the thrust device is pressed again. When the tip is retracted into the barrel while not in use, the end of the thrust device protrudes outward from the second opening.

Accordingly, the retractable washable marker device of the present invention is particularly advantageous as it provides an improved marker. As a result, the device does not present a choking hazard and is not susceptible to inadvertently drying out while doing so. Further, the lack of a cap allows the device to be easily used by users with limited physical dexterity. In this manner, the retractable washable marker device overcomes the limitations of existing markers known in the art.

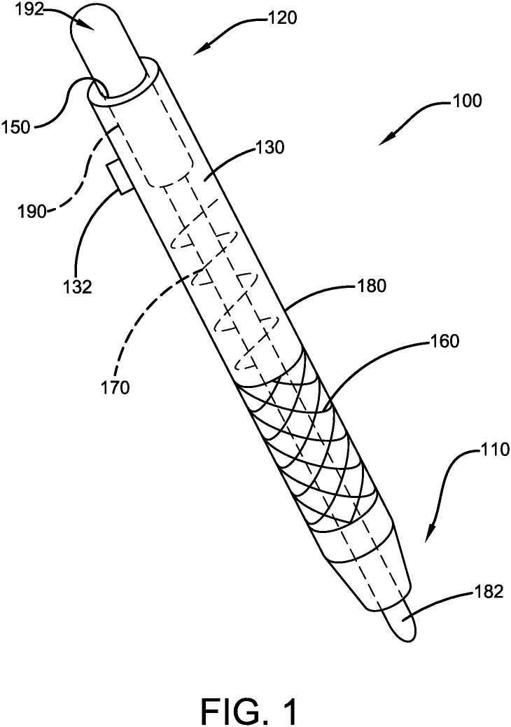

Referring initially to the drawings, FIG. 1 illustrates a perspective view of one potential embodiment of a retractable washable marker device 100 of the present invention with a marker member tip 184 extended in accordance with the disclosed architecture. The device 100 is primarily comprised of a barrel 130, a thrust device 190, and a marker member 180 saturated with an ink 182. In the preferred embodiment, the barrel 130 is cylindrical in shape. However, the barrel 130 may be a plurality of shapes such as, but not limited to, square, triangular, octagonal, polygonal, etc., that allow the barrel 130 to be gripped easily by a user. The barrel 130 and all components of the device 100 are preferably comprised of a rigid plastic material such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc., unless otherwise specified herein. The barrel 130 may also be comprised of at least one grip 160 (preferably positioned at the first end 110 of the barrel 130) that aids a user in gripping the barrel 130 during use. The grip 160 is preferably comprised of a textured, recessed, and/or non-textured material that is non-slip such as, but not limited to, silicone, latex, neoprene, EPDM, PVC foam, polyethylene, sponge rubber, silicone foam, urethane, cork, ridged and/or recessed rubber, felt, acrylic, polyester & SBR, etc.

At least one marker member 180 is positioned within the barrel 130. The marker member 180 is preferably made from a polyester material. However, the member 180 may be made from an absorbent material known in the art such that the member 180 absorbs ink 182. The tip 184 of the member 180 is preferably made from a felt material or other marker material known in the art. The ink 182 is preferably any washable, non-toxic ink of any color known in the art. However, the ink 182 may be permanent, non-washable ink in another embodiment.

The tip 184 exits the first end 110 of the barrel 130 through the first opening 140 of the first end 110 when the end 192 of the thrust device 190 is pressed downward into the barrel 130. This causes at least one spring 170 within the barrel 130 to press against the opening 140 and forces the tip 184 out of the opening 140. The spring 170 may be any spring type known in the art.

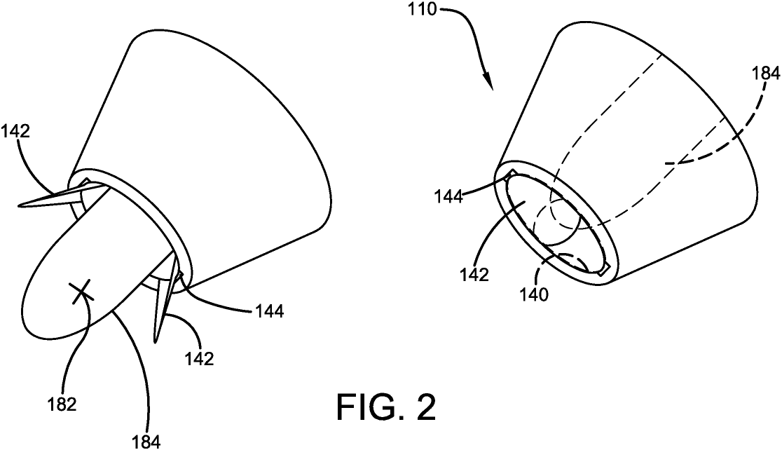

FIG. 2 illustrates multiple perspective views of one potential embodiment of a retractable washable marker device 100 of the present invention with a marker member tip 184 extended and retracted in accordance with the disclosed architecture. The opening 142 is preferably comprised of two (but at least one) flexible silicone flaps 142. The flaps 142 ensure the tip 184 does not dry out when retracted in the barrel 130 (when not in use) by sealing the barrel 130 from the outside air. In one embodiment, each flap 142 is rigid and is attached to the opening 140 via at least one hinge 144. The hinge 144 is preferably a spring-loaded hinge but may be any hinge type known in the art. The hinge 144 is pushed open when the tip 184 extends from the barrel 130 and automatically closes after the tip 184 is retracted into the barrel 130.

The thrust device 190 is located at the second end 120 and can be pushed downward into the barrel 130 through a second opening 150. Pushing the thrust device 190 downward causes the tip 184 to protrude from the first opening 140 and remain protruded until the thrust device 190 is pressed again. When the tip 184 is retracted into the barrel 130 while not in use, the end 192 of the thrust device 190 protrudes outward from the second opening 150. The end 192 may be any shape known in the art that may be angled, convex, concave, etc., that allows a user to easily depress the thrust device 190 using the end 192.

The barrel 130 may also be comprised of at least one fastener 132. The fastener 132 allows the device 100 to attach to nearby surfaces, garments, objects, etc. The fastener 132 may be any fastener known in the art. However, the fastener 132 is preferably a magnet or a clip. In one embodiment, the barrel 130 may be transparent to allow a user to view the saturation level of the marker member 180 and tip 184.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “retractable washable marker device” and “device” are interchangeable and refer to the retractable washable marker device 100 of the present invention.

Notwithstanding the foregoing, the retractable washable marker device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the retractable washable marker device 100 as shown in the FIGS. are for illustrative purposes only, and that many other sizes and shapes of the retractable washable marker device 100 are well within the scope of the present disclosure. Although the dimensions of the retractable washable marker device 100 are important design parameters for user convenience, the retractable washable marker device 100 may be of any size, shape, and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A retractable washable marker device comprising:
a barrel;
a thrust device;
a spring;
a marker member comprised of a tip;
an ink;
a first opening; and
a flap.

2. The retractable washable marker device of claim 1, wherein the barrel is comprised of a cylindrical shape.

3. The retractable washable marker device of claim 1, wherein depressing the thrust device extends the tip from the first opening.

4. The retractable washable marker device of claim 1, wherein the ink is comprised of a non-toxic ink.

5. A retractable washable marker device comprising:
a barrel;
a thrust device comprised of an end;
a spring positioned within the barrel;
a marker member comprised of a tip;
an ink;
a first opening; and
a flap.

6. The retractable washable marker device of claim 5, wherein the flap is comprised of a flexible material.

7. The retractable washable marker device of claim 5, wherein the marker member is comprised of an absorbent material.

8. The retractable washable marker device of claim 7, wherein the marker member absorbs the ink.

9. A retractable washable marker device comprising:
a barrel comprised of a grip and a fastener;
a thrust device comprised of an end;
a spring positioned within the barrel;
a marker member comprised of a tip;
an ink;
a first opening;
a flap; and
a hinge.

10. The retractable washable marker device of claim 9, wherein the barrel is comprised of a transparent material.

11. The retractable washable marker device of claim 9, wherein the flap is comprised of a rigid material.

12. The retractable washable marker device of claim 9, wherein the grip is comprised of a non-slip material.

13. The retractable washable marker device of claim 12, wherein the non-slip material is comprised of a textured material or a recessed material.

14. The retractable washable marker device of claim 9, wherein the ink is comprised of a washable ink.

15. The retractable washable marker device of claim 9, wherein the fastener is comprised of a clip.

16. The retractable washable marker device of claim 9, wherein the fastener is comprised of a magnet.

17. The retractable washable marker device of claim 9, wherein the end is comprised of a flat, a convex, or a concave shape.

18. The retractable washable marker device of claim 9, wherein the hinge is comprised of a spring-loaded hinge.

19. The retractable washable marker device of claim 9, wherein the tip is comprised of a felt tip.

20. The retractable washable marker device of claim 19, wherein the felt tip is comprised of an absorbent felt material.
